(19) United States
(12) Patent Application Publication
(10) Pub. No.: US 2012/0174494 A1
(43) Pub. Date: Jul. 12, 2012

(54) ROOF GUTTER CLEARING CATAPULT

(76) Inventor: Frederick Ollison, IV, Grosse Pointe Farms, MI (US)

(21) Appl. No.: 13/347,895

(22) Filed: Jan. 11, 2012

Related U.S. Application Data
(60) Provisional application No. 61/431,559, filed on Jan. 11, 2011.

(51) Int. Cl. E04D 13/076; B65D 25/00; B08B 7/00

(52) U.S. Cl. 52/12; 134/42; 220/694

(57) ABSTRACT

A roof gutter clearing system includes an insert situated atop a roof gutter, the insert including filtering means for allowing passage of water and retaining debris, the insert being eversible by rotation about hinges, the eversion causing the ejection of debris. The roof gutter clearing system includes a spring assembly to drive the eversion of the insert by transmission of force stored in at least one spring and an actuation assembly to tension the spring assembly and release the spring assembly to drive the eversion of the insert. A method of clearing a roof gutter of debris including the steps of trapping debris in an eversible insert, the insert being situated atop the roof gutter and operatively connected to a tensioned spring assembly; and releasing the spring assembly to apply eversive force against the insert to cause eversion of the insert and ejection of the debris.

### TECHNICAL FIELD

The present invention relates to devices for the clearance of debris from receptacles, more specifically to roof gutter screens that are eversible by spring action to eject accumulated seasonal debris.

### BACKGROUND OF THE INVENTION

Roof gutters perform the vital function of directing rain water and snow melt from the roof of a structure to sites distant from the walls and foundations of the structure, such as absorbent ground or storm sewers. Gutters cannot perform their function, however, when they become clogged with leaves and other debris. Gutters therefore require regular debris clearing. The operation is commonly performed by an operator climbing a ladder to scoop or brush out the debris, or to clear stationary or “static” guards. This is a taxing and often perilous procedure. Reliance on static guards without manual clearance merely changes the site of the clog, from the downspout to the guard.

Eversible gutter screen inserts to allow a user to clear gutters from ground level are known in the art. Typical gutter clearing inserts are disclosed by U.S. Pat. Nos. 753,660, 3,630,383, 3,740,787, and 6,493,994. These inserts are comprised of water permeable mesh or grating material and are attached by hinges or clamps to the front (building exterior) side of a gutter. Various types of handle or ring are exposed on the exterior side of the gutter. The inserts are eversible by downward and/or outward force exerted on the handles or rings, the force causing the forward rotation of the insert on its hinges. To eject debris, an operator at ground level exerts the eversive force by means of a hooked pole or a pull rope system.

There is a need for gutter clearing systems including an eversion mechanism that everts the insert without direct application of eversive force by a user, with a user having only to activate the eversion mechanism in order to eject debris.

### SUMMARY OF THE INVENTION

The present invention provides a roof gutter clearing system including eversible screening means for collecting and ejecting debris, spring means for storing energy and for applying the energy as eversive force against the eversible screening means, and actuation means for tensioning the spring means and for releasing the spring means to apply eversive force against the screening means, the eversive force causing eversion of the eversible screening means.

The present invention also provides a roof gutter clearing system including a pivoting eversible insert situated atop a roof gutter, the insert including filtering means for collecting debris, the insert being eversible to eject the debris, a spring assembly operatively connected to the insert, the spring assembly being tensionable to store energy and releasable to apply the energy as eversive force applied against the insert, and an actuation assembly operatively connected to the spring assembly, the actuation assembly being operable to tension the spring assembly to store energy, the actuation assembly being additionally operable to release the spring assembly to apply the energy as eversive force against the insert to cause eversion of the insert.

The present invention further provides a method of clearing a roof gutter of debris, including the steps of trapping debris in a pivotable insert, the insert being situated atop the roof gutter and operatively connected to a spring assembly tensioned to store energy; and releasing the spring assembly to apply the energy as eversive force against the insert to cause eversion of the insert and ejection of the debris.

The present invention still further provides a receptacle clearing system including eversible screening means for collecting and ejecting debris, spring means for storing energy and for applying the energy as eversive force against the eversible screening means, and actuation means for tensioning the spring means and for releasing the spring means to apply eversive force against the screening means, the eversive force causing eversion of the eversible screening means.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1A shows a front perspective view of a gutter clearing system according to the present invention with the insert in resting position, with unlabelled straight dotted arrows indicating forces exerted on the system, and unlabelled curved arrows indicating resulting movement of the insert;

FIG. 1B shows the gutter clearing system with the insert in the process of eversion;

FIG. 1C shows the gutter clearing system with the insert being returned to resting position (lower panel);

FIG. 2 shows a cross section of a gutter clearing system mounted on a gutter by means of a clip channel assembly;

FIG. 3 shows a top view of an embodiment of the gutter clearing system including a spring-loaded striker, with the insert disproportionately enlarged and transparent to show detail;

FIG. 4A shows a lateral schematic view of the gutter clearing system with the insert in resting position;

FIG. 4B shows a lateral schematic view of the gutter clearing system with the insert in the process of eversion;

FIG. 4C shows a lateral schematic view of the gutter clearing system with the insert reaching full eversion, with an unlabelled curved arrow indicating direction of motion of the insert;

FIG. 5A shows a front elevation of the gutter clearing system as shown in FIG. 4A, with the insert in resting position;

FIG. 5B shows a front elevation of the gutter clearing system as shown in FIG. 4B, with the insert in the process of eversion;

FIG. 5C shows a front elevation of the embodiment of the gutter clearing system as shown in FIG. 4C, with the insert reaching full eversion;

FIG. 6 shows a top view of an alternative configuration of the spring-loaded striker;

FIG. 7A shows a front elevation of the roof gutter clearing system as shown in FIG. 6, showing a striker with its spring in the tensioned position, with the inset showing a lateral schematic view of the same subject;

FIG. 7B shows a front elevation of the roof gutter clearing system, with the striker in released condition, with the inset showing a lateral schematic view of the same subject, and with unlabelled curved arrow indicating the movement of the insert;

FIG. 8A shows a perspective frontal view of an alternative embodiment of the gutter clearing system including a spring-loaded hinge assembly;

FIG. 8B shows a cross section of a gutter clearing system including a spring-loaded hinge assembly, attached to the wall of a gutter;

FIG. 8C shows a cross section of a trip assembly;

FIG. 8D shows a cross section of a trip assembly including a housing;

FIG. 9A shows a cross section of a gutter clearing system including a spring-loaded hinge assembly and a magnetic trip assembly;

FIG. 9B shows a detailed cross section of a magnetic trip assembly; and

FIG. 10 shows an angled embodiment of the roof gutter clearing system.

### DETAILED DESCRIPTION OF THE INVENTION

The preferred embodiment of the receptacle clearing system of the present invention is the roof gutter clearing system generally shown at 10. It will be understood that the present invention is readily adaptable to clear debris from any type of receptacle.

The roof gutter clearing system 10 is situated atop a rain gutter G mounted on a structure such as a house. In the following description, an exterior or outward direction is defined as the direction away from the structure on which the roof gutter clearing system 10 is mounted, an interior or inward direction is the direction opposite the exterior or outward direction, an upward or upper direction is defined as the direction away from the ground, and a downward or lower direction is defined as the direction toward the ground. “Atop” indicates a condition of resting upon upper surfaces of a gutter G.

The roof gutter clearing system 10 includes a pivoting, eversible insert 12 having filtering means 22 for collecting debris and allowing water to pass through; a spring assembly 25 operatively connected to the insert 12, the spring assembly 25 being tensionable to store energy and releasable to apply the energy as eversive force against the insert 12 to cause its eversion, thereby ejecting collected debris; and an actuation assembly 40 operatively connected to the spring assembly 25. The actuation assembly 40 both tensions the spring assembly 25 to store energy and releases the spring assembly 25 to apply eversive force against the insert 12. Eversive force is defined as any force which tends to cause the insert 12 to evert sufficiently to eject collected debris.

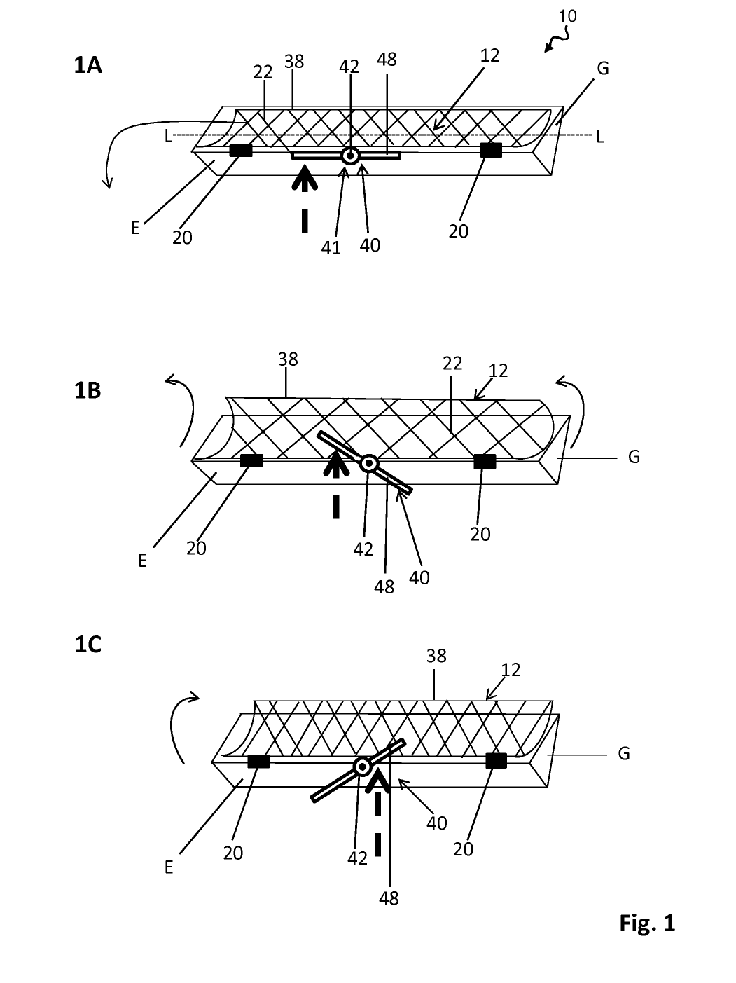

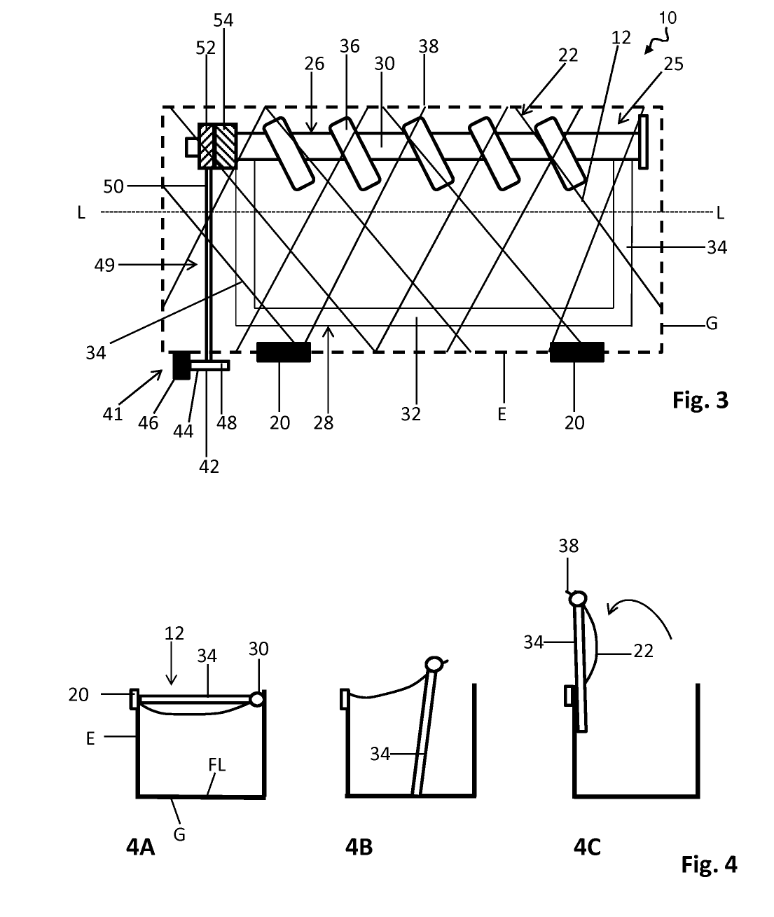

The action of the insert 12 is summarized in FIG. 1. In resting position, the insert 12 is situated atop the gutter G, with the spring assembly (not shown) tensioned by the actuation assembly 40 (FIG. 1A); the insert 12 pivotingly everts upon release of the tension of the spring assembly (not shown) by the actuation assembly 40 (FIG. 1B) and the insert 12 is pivotingly returned to resting position and the spring assembly (not shown) is re-tensioned by the actuation assembly 40 (FIG. 1C). Although the insert 12 is preferably situated atop the upper sides of a gutter G, as shown in FIG. 4A, it can alternatively be situated within the gutter G, at any height above the floor Fl of the gutter G.

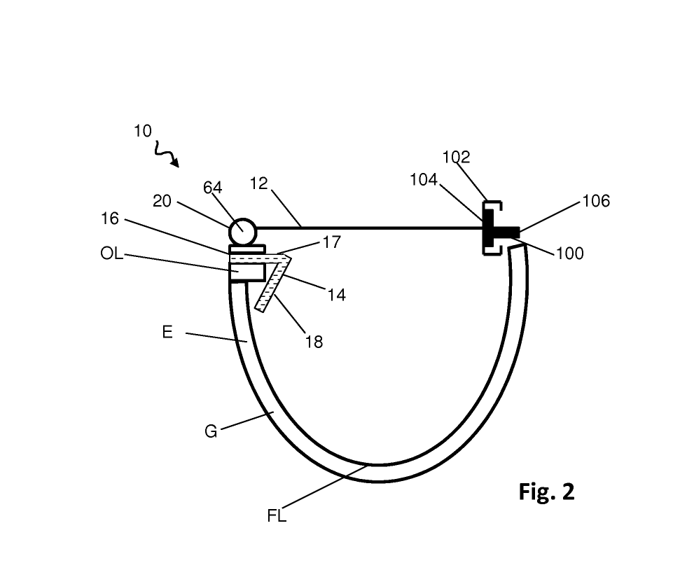

The roof gutter clearing system 10 is attachable to the exterior side E of an existing gutter G by attachment means such as the clip channel 14. As best seen in FIG. 2, the clip channel 14 includes an upper platform member 16 extending inward across the outer lip OL of the gutter G to terminate in an inner end 17; and a lower leg member 18 extending downward from the inner end 17 of the platform member 16, to contact the inner face of the of the exterior side E of the gutter G. The platform member 16 and the leg member 18 form an angle such that the combination of the platform member 16 and the leg member 18 grippingly engages the exterior side E of the gutter G. The platform member 16 and leg member 18 can be fabricated as a single unit or assembled from separate members. Any other suitable attachment means known in the art can additionally or alternatively be included, such as welds, bolts, and adhesives (not shown). The roof gutter clearing system 10 may alternatively be incorporated into a gutter during fabrication of the gutter

The insert 12 is attached to the platform member 16 of the clip channel 14 by hinge means 20 for allowing the insert to rotate about the outer lip OL of the gutter G. The hinge means 20 can include any pivoting means known in the art, such as hinges, spring-assisted hinges, or clasps.

The insert 12 includes filtering means 22 for allowing water to pass freely while preventing the passage of debris large enough to obstruct a downspout. The filtering means 22 can include a mesh of plastic or metal strands, and can be of any mesh size that allows water to pass freely while retaining debris. Alternatively, filtering means 22 can include a grid of rigid or semi-rigid metal or plastic (not shown).

The roof gutter clearing system 10 also includes a spring assembly 25 to exert eversive force against insert 12. In one embodiment, the spring assembly 25 includes a spring-loaded striker generally shown at 26 and best illustrated in FIG. 3. Preferably, the striker 26 includes a striker bar 28 including a bar-like shaft member 30 having two opposite ends (not shown). Two parallel bar-like arms 34 extend perpendicularly from the shaft member 30. A bar-like crossmember 32 having two opposite ends (not shown) is connected to the shaft member 30 by the two arms 34, with each end of the crossmember 32 connected to one arm 34, the arms 34 being mutually parallel and coplanar with both the shaft member 30 and the crossmember 32. The shaft member 30 is pivotable about a mount or hinge (not shown). The striker 26 also includes a coiled spring 36 situated about shaft member 30. The spring 36 is attached to the striker 26 such that the spring 36 is tensioned when the shaft member 30 is pivoted in a first direction, storing potential energy. Release of the tension of the spring 36 releases the potential energy, converting it to kinetic energy to pivot the shaft member 30 and its attached crossmember 32 forcefully in a second and opposite direction to apply eversive force against the insert 12. The specific configuration of attachment of the spring 36 to the striker 26 can be any known in the art of spring-loaded mechanisms, for example the mousetrap configuration disclosed in U.S. Pat. No. 744,379, which is incorporated by reference herein.

The striker 26 is preferably composed of a steel alloy, but can be of any metal or plastic that possesses sufficient tensile strength to evert the insert 12 and sufficient weather resistance to withstand prolonged outdoor service. Similarly, the spring 36 is preferably comprised of high tensile steel alloy but can be of any metal or plastic that can sustain sufficient tension and is sufficiently weather resistant.

In operation, the spring 36 causes the shaft member 30 to rotate the attached crossmember 32 forcefully against either the insert 12 or the floor FL of the gutter G as will be described below.

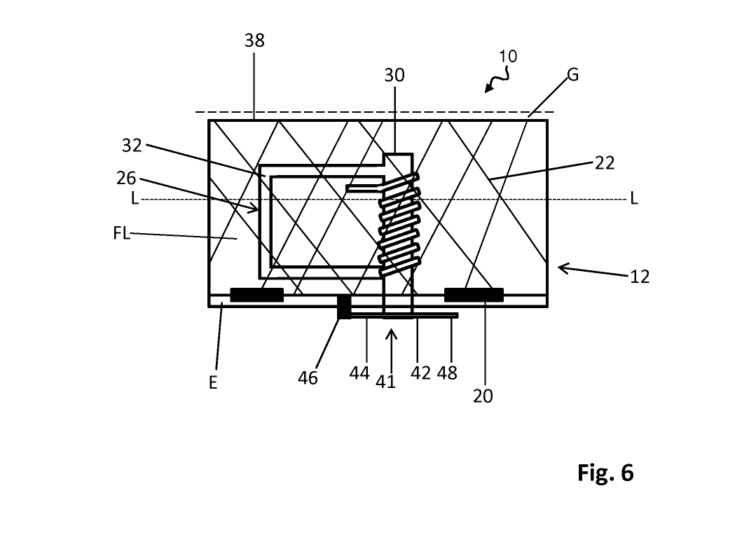

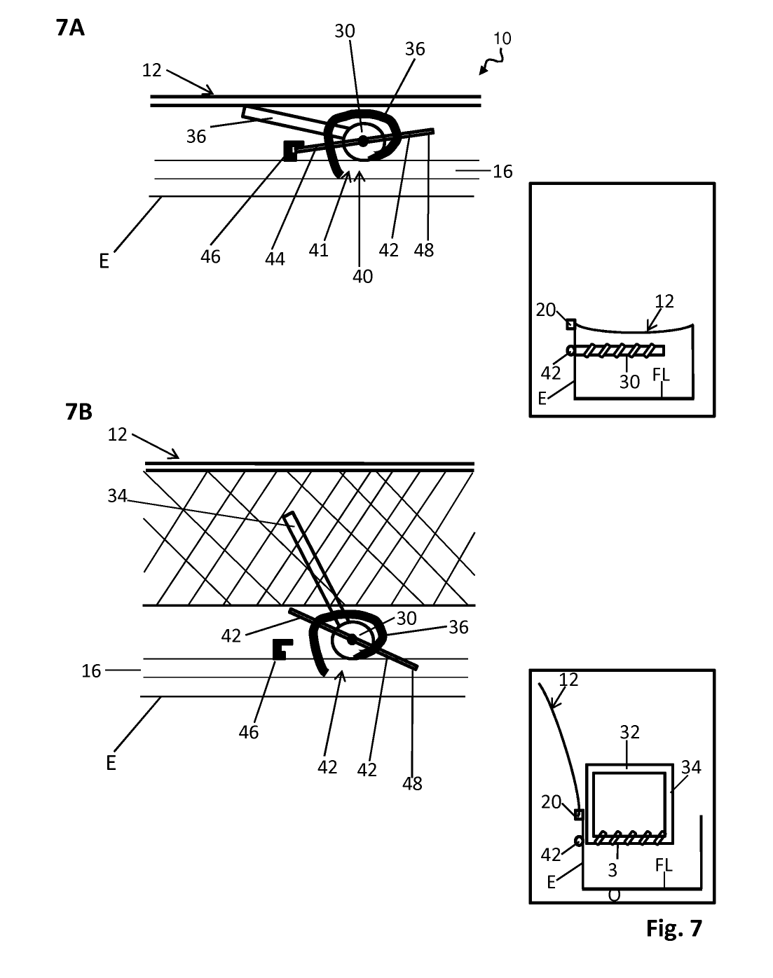

The striker 26 can be mounted in any position or orientation that permits the forceful movement of the crossmember 32 to deliver eversive force against the insert 12. Preferably, the striker 26 is attached to the lower surface of the insert 12, as shown in FIGS. 3, 4, and 5. This allows the roof gutter clearing system 10 to be installed upon an existing gutter G as a single integrated unit. The striker 26 can alternatively be mounted on one of the sides of the gutter G or on the floor FL of a gutter G, as shown in FIGS. 6 and 7.

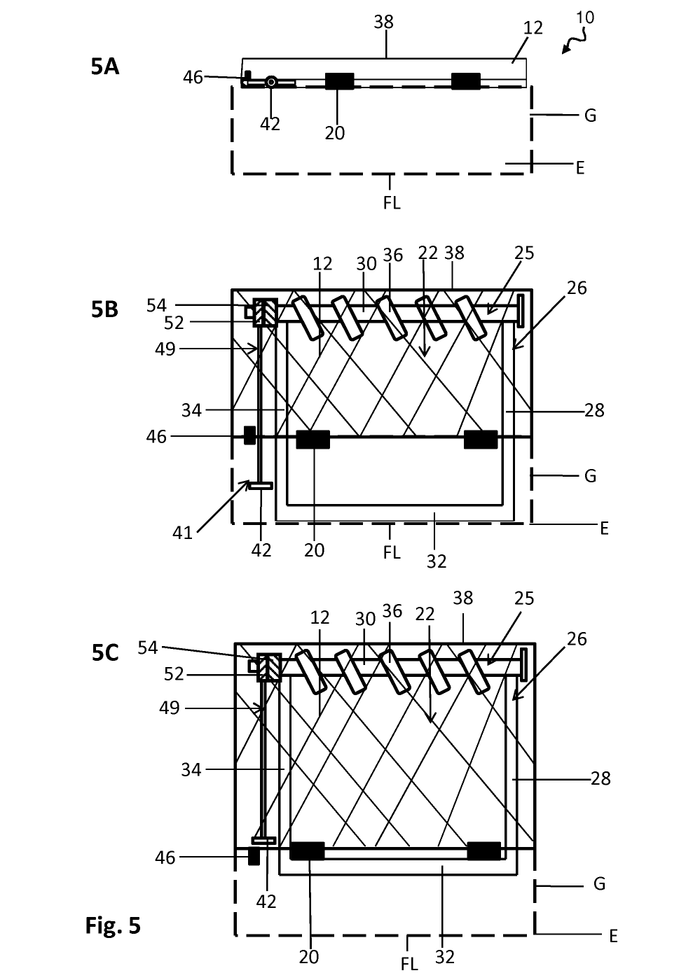

In one embodiment of the present invention, illustrated in FIG. 3, the striker 26 is mounted on the lower surface of insert 12. Preferably, the shaft member 30 is attached to the lower surface of the insert 12 in proximity to the free, unhinged edge 38 of insert 12. The striker 26 is preferably is oriented with the crossmember 32 parallel to the longitudinal axis L of the gutter G. The striker 26 is mounted at a distance from the floor FL of the gutter G such that the crossmember 32 strikes the floor FL when tension of the spring 36 is released. In operation, referring to FIGS. 4 and 5, with the insert 12 in resting position, crossmember 32 is parallel to the floor Fl of the gutter G and the spring 36 is under tension (FIGS. 4A, 5A). When the tension on the spring 36 is released, the crossmember 32 strikes the floor FL of the gutter G, causing the shaft member 30 to recoil upward, thereby exerting force against the free edge 38 of the insert 12. In reaction, insert 12 pivots on its hinges 20 and everts, catapulting any trapped debris out and away from the gutter and the structure to which it is attached (FIGS. 4B, 5B). Stops (not shown) arrest the insert 12 at a position approximately 180 degrees from resting position, with its upper surface external to the gutter G and parallel to the ground (FIGS. 4C, 5C). A user then pivots the screen in the opposite direction and pushes it downward to return the screen to resting position. This operation is accomplished for example by manipulation with a pole (not shown).

Other mounting modes and orientations of the striker 26 are possible, though less desirable. For example, the striker 26 can be mounted on the exterior side E of the gutter G, upon the platform member 16 of the clip channel 4, as shown in FIGS. 6 and 7. The striker 26 can alternatively be mounted on the floor FL of gutter G (not shown). In these alternative embodiments, the crossmember 32 pivots forcefully upward to strike the lower surface of the insert 12, forcing the insert 12 to evert as previously described, and as best shown in FIG. 7. Preferably, the striker 26 is oriented perpendicular to the long axis of the gutter G, as illustrated in FIGS. 6 and 7. Upon release of the tension of the spring 36, the striker 26 exerts an upward force that sweeps against the insert 12 from side to side along the long axis of the gutter G. The striker 26 can alternatively be situated with the crossmember 32 oriented parallel to the long axis of the gutter G (not shown). It will be understood that the spring assembly 25 need not be limited to the striker 26. The roof gutter clearing system 10 of the present invention can be include any means of storing potential energy and directing it in a manner that causes eversion of the insert 12. For example, a spring-loaded telescoping plunger having at least a proximal segment and a distal segment (not shown) can be mounted on the lower surface of insert 12. The distal segment of the plunger (not shown) is inducible, by the release of spring tension, to project forcefully downward to strike the floor Fl of a gutter G. The downward striking of the floor FL causes the insert 12 to recoil and evert (not shown).

The roof gutter clearing system 10 can additionally include an actuation assembly 40 to tension the spring assembly 25, arrest the spring assembly 25 in tensioned condition, and, at a desired subsequent time point, release the spring assembly 25 to cause eversion of the insert 12.

The actuation assembly 40 can include a pivoting actuation assembly 41 best shown in FIGS. 7A and 7B, wherein a pivotable lever 42 is operatively connected to the shaft member 30 of the striker 26. The lever 42 includes a first end 44 and an opposite second end 48. The first end 44 of the lever 42 is arrestable against the tension of the spring 36 by rotation of the lever 42 in a first direction and entrapment of the first end 44 under a detent 46. In the example illustrated in FIG. 6, the first direction is counterclockwise. The first end 44 of the lever 42 is releasable from the detent 46 by rotation in a second direction, which is the clockwise direction in the example illustrated in FIG. 6. This rotation can be provided by either upward-directed force against the first end 44, or downward-directed force against the second end 48 of the lever 42. Preferably, rotation is provided by upward-directed or “push-up” force against the first end 44 of the lever 42, but downward-directed “push down” force against the second end 48 can also be used. Preferably, the forces against the lever 42 are supplied by a remote force transfer device, preferably a user operated pole (not shown). Release of the first end 44 of the lever 42 from the detent 46 causes the release of the tension of the spring 36, allowing the spring 36 to forcefully pivot the striker 26, which causes eversion of the insert 12.

In operation, a user pivots the insert 12 downward on its hinges 20 until it reaches its resting position. The pivoting is preferably accomplished by manipulation of the insert 12 with a hooked pole (not shown). A loop (not shown) engagable with the pole (not shown) can be included on the upper surface of the insert 12 to facilitate this manipulation. The user tensions the spring 36 by applying upward force to the second end 48 of the lever 42, causing the lever 42 to pivot against the tension of the spring 36, and causing the first end 44 of the lever 42 to become trapped under the detent 46. The user releases the tension of the spring 36 by applying upward force against the first end 44 of the lever 42 to force it out of the detent 46, thereby releasing the tension of the spring 36 and causing the striker 26 to evert the insert 12 as previously described.

In the embodiment illustrated in FIGS. 3, 4, and 5, wherein the shaft member 30 of the striker 26 is not directly accessible from the exterior side E of the gutter G, the pivoting actuation assembly 41 additionally includes a transmission assembly 49 to transmit force exerted on the lever 42 to the shaft member 30. For example, the lever 42 can be connected to a the proximal end of a gearshaft 50 about whose distal end is disposed a worm 52 operatively engaged with a worm gear 54, which is operatively connected to the shaft member 30 of striker 26, as best shown in FIG. 3. In operation, rotation of the lever 42 rotates the gearshaft 50 and worm 52 in a direction parallel to the long axis L of the gutter G. This motion is translated by the worm gear 54 into motion perpendicular to the long axis of the gutter G, thereby transmitting force that rotates the shaft member 30 and tensions the spring 36.

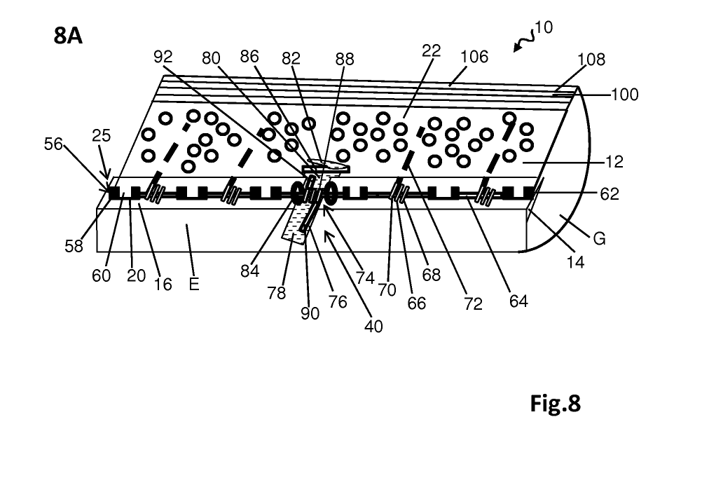

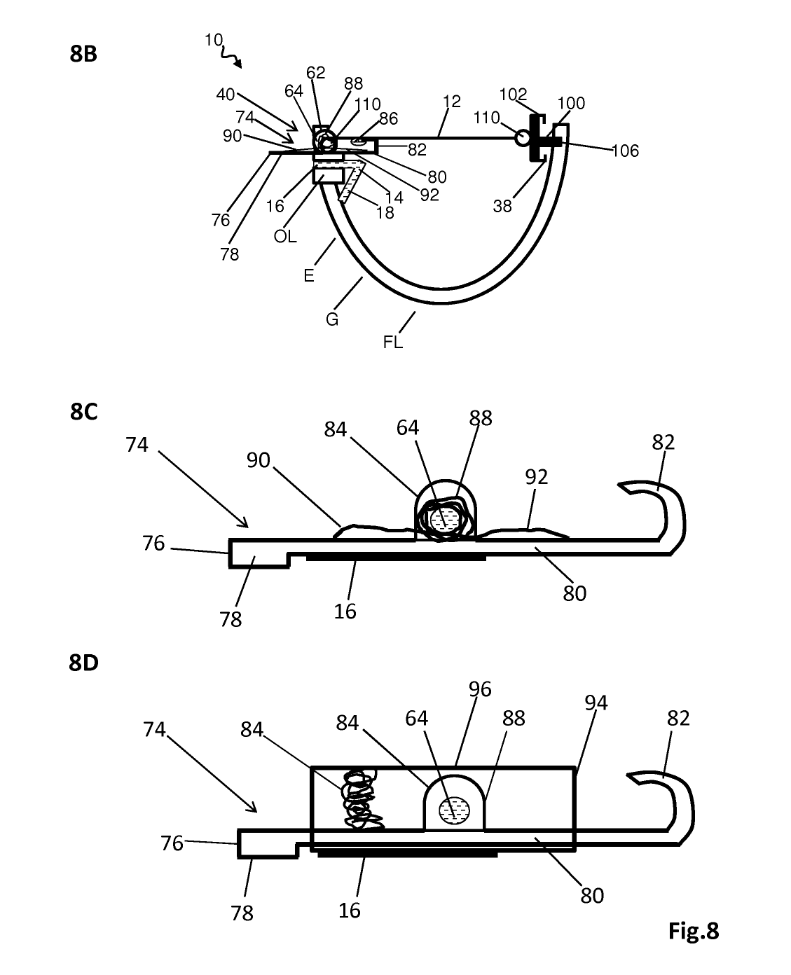

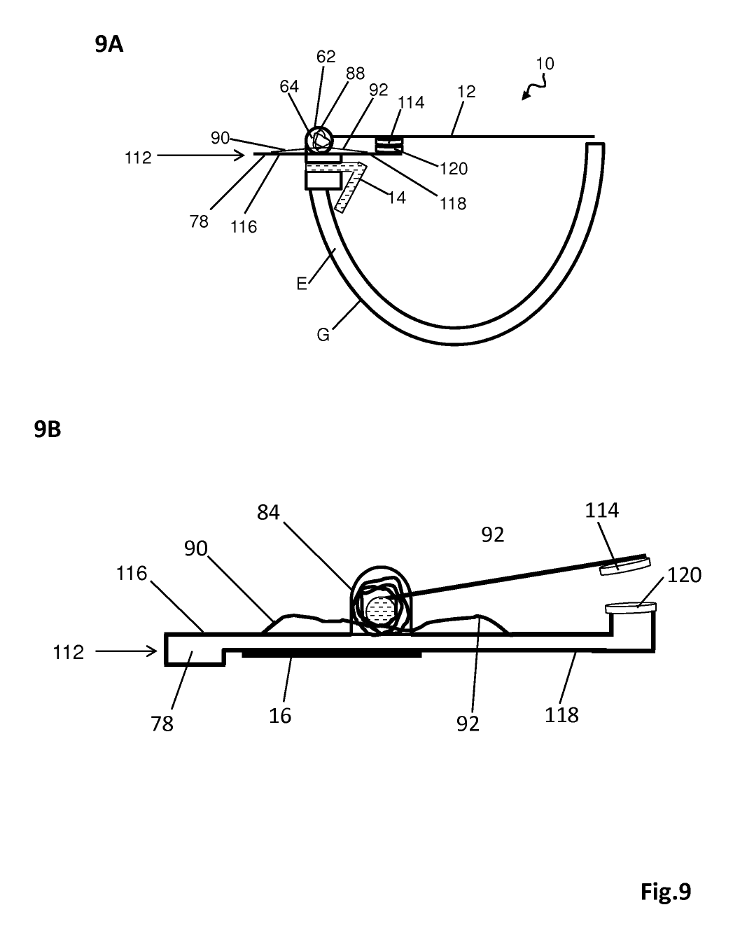

In the preferred embodiment of the roof gutter clearing system 10, the spring assembly 25 includes a spring-loaded hinge assembly, generally shown at 56, rather than a spring-loaded striker 26. In this embodiment, best shown in FIGS. 8A-8D, and 9A, the spring-loaded hinge assembly 56 includes at least one hinge 20, preferably a plurality of hinges 20. In an example configuration, each hinge 20 includes at least one proximal hollow knuckle 58 extending inward from the platform member 16 of the clip channel 14, the at least one proximal hollow knuckle 58 interlacing with at least one hollow distal knuckle 60 extending outward from the insert 12. The at least one proximal hollow knuckle 58 and at least one distal hollow knuckle 60 are arranged in substantially axial alignment such that they form segments of a hinge barrel 62. A hinge pin 64 extends through the hinge barrel 62. The hinge pin 62 is locked into place by expanded terminal tips (not shown) or by any suitable pin-anchoring means known in the art. At least one helical hinge spring 66, preferably a plurality of hinge springs 66, coils about the hinge pin 62. Each hinge spring 66 includes a first end member 68 in contact with the upper surface of the platform member 16 and a second end member 70 in contact with a spoke-like spring arm 72 situated on the lower surface of the insert 12. The spring arms 72 extend inward from the outer edge of the insert 12 and can be of any length suitable to provide leverage for the hinge springs 66. In an alternative configuration, (not shown), the hinge springs 66 are contained within the hinges 20, residing within the segments of the hinge barrel 62 formed by the proximal and distal hollow knuckles 58 and 60, respectively. The hinge springs 66 are biased to evert the insert 12 by applying upward force to the spring arms 72. Thus, when the insert 12 is held in the resting position, the hinge springs 66 are in a tensioned condition.

The spring-loaded hinge assembly 56 is operatively connected to an actuation assembly 40. The actuation assembly 40 preferably includes a trip assembly 74 to arrest the insert 12 in the resting position, maintain the hinge springs 66 in a tensioned condition, and, at a desired subsequent time, to release the tension of the hinge springs 66 to drive the eversion of the insert 12. The trip assembly 74 includes a flattened bar-like trigger 76. As illustrated in FIG. 8, the trigger 76 includes an outer tongue member 78 extending outward toward the exterior of the gutter G; and an inner hook member 80 extending inward to terminate in an upward arcing hook 82. The trigger 76 additionally includes a pivot channel 84 extending laterally through the trigger 76, at a point generally equidistant between the tongue member 78 and the hook member 80. The hinge pin 64 extends through the pivot channel 84 of the trigger 76, so that the trigger 76 is pivotally engaged with the hinge pin 64. Also included in the trip assembly 74 is a loop-like catch 86 situated on the lower surface of the insert 12. The hook member 80 of the trigger 76 is situated to align with the catch 86 and to be engageable with the catch 86. The trip assembly 74 also includes a helical trigger spring 88 operatively connected to the trigger. The trigger spring 88 is configured to bias the trigger 74 to pivot the hook member 80 upward, so that it tends to engage the catch 86. With the hook member 80 engaged with the catch 86, the hinge springs 66 are maintained in tensioned condition. Release of the hook member 80 from the catch 86 releases the tension of the hinge springs 66, and the released spring tension causes the eversion of the insert 12.

In one embodiment of the trip assembly 74 illustrated in FIGS. 8B, and 8C, the trigger spring 88 coils about the hinge pin 64, and includes a first arm member 90 in contact with the upper surface of the tongue member 78 and a second arm member 92 in contact with the upper surface of the hook member 80. The upward bias of the hook member 80 can alternatively be produced by an alternative embodiment of the trip assembly 74 that includes a housing 94. As illustrated in FIG. 8D, the trip assembly 74 includes a trigger 76 that is at least partially enclosed within the housing 94, which is box-like, and which includes at least a roof 96. The housing 94 encloses at least an area of the trigger 76 surrounding the pivot channel 84. The housing 94 also includes a housing spring 98 resiliently connecting the roof 96 of the housing 94 to the tongue member 78 of the trigger. The housing spring 98 is biased to exert downward force on the tongue member 78, so that the trigger 76 tends to pivot about the hinge pin 64 to bring the hook member 80 upward to engage the catch 86. Alternatively, any spring configuration that biases the hook member 80 into engagement with the catch 86 is suitable for inclusion in the present invention.

In operation, a user pivots the insert 12 downward against the tension of the spring hinges 66 until the insert 12 reaches its resting position and the catch 86 engages with the hook member 80 of the trigger 76. This pivoting operation is preferably performed by means of a hooked pole (not shown). A loop (not shown) engagable with the pole (not shown) can be included on the upper surface of the insert 12 to facilitate the operation. With the insert 12 in resting position, the hinge springs 66 are in tensioned condition. To evert the insert 12, the user applies upward force to the tongue member 78 of the trigger 76 to pivot the hook member 80 out of engagement with the catch 86. With the catch 86 disengaged, the tension of the hinge springs 66 is released, and the hinge springs apply upward force against the spring arms 72 of the insert 12, forcing the insert 12 to evert by pivoting upward and outward on its hinges 20.

Alternatively, the actuation assembly 40 includes a pivoting magnetic trip assembly 112 situated on an exterior wall E of a gutter G, and an insert magnet 114 situated on the underside of the insert 12, as illustrated in FIG. 9. The magnetic trip assembly 112 is pivotingly engaged with the hinge pin 64, and includes a magnetic trigger 116 having an outer tongue member 78 extending toward the exterior of the gutter G, and an opposite inner magnet member 118 extending toward the insert 12. The magnetic trigger 116 includes at least one trigger magnet 120 situated on an upper surface of the magnet member 118. The at least one trigger magnet 120 is aligned with the insert magnet 114 so that it is magnetically engageable with the insert magnet 114. The two magnets engage when the insert 12 is pivoted into resting position, against the bias of the hinge springs 66, as shown in FIG. 9A. The engagement of the trigger magnet 120 with the insert magnet 114 therefore arrests the insert 12 in resting position and tensions the hinge springs 66.

The magnetic trigger 116 is pivotable about the hinge pin 64, so the application of force to the tongue member 78 pivots the magnet member 118 downward to disengage the trigger magnet 120 from the insert magnet 114. Disengagement of the trigger magnet 120 from the insert magnet 114 releases the tension of the at least one hinge spring 66. The released tension drives the forceful pivoting of the at least one hinge 20 to apply eversive force against the insert. It will be understood that multiple insert magnets 114 and trigger magnets 120 can be included in the magnetic trip assembly 112. Alternatively, either the insert magnet 114 or the trigger magnet 120 can be substituted for by a suitably dimensioned piece of ferrous metal sufficiently attracted by a magnet. The insert magnets 114 and trigger magnets 120 are preferably all-weather magnets.

Any of the previously described configurations of the actuation assembly 40 can be operated by a remote force transfer device other than a user-operated pole. Alternative remote force transfer devices include a rope, a chain, a pulley assembly, or an electric motor, these devices being of any suitable type known in the art. For example, in the case of the pivoting actuation assembly 41 illustrated in FIGS. 7A and 7B, a first chain (not shown) is affixed to the first end 44 of the lever 42, and a second chain (not shown) is affixed to the second end 48 of the lever 42. The first and second chains (not shown) extend downward to ground level. In operation, a user tensions the spring 36 by pulling downward on the first chain (not shown) to cause the lever 42, to pivot against the tension of the spring 36, and to cause the first end 44 of the lever 42 to become trapped under the detent 46. The user applies downward force on the second chain (not shown) to release the first end 44 of the lever 42 from the detent 36, thereby releasing the tension of the spring 36 and allow the spring 36 to forcefully pivot the striker 26. As another example, in an embodiment of the invention including a pivoting actuation assembly 41, an electric motor (not shown) is mounted on or in proximity to roof gutter clearing system 10 and is operatively connected directly or indirectly to the shaft member 30 and the lever 42. The spring 36 is tensioned by the application of the torque of the electric motor (not shown) to the shaft member 30 to pivot the shaft member 30 and tension the spring 36. The insert is everted by applying the torque of the electric motor to the second end 48 of the lever 42 to force the first end 44 of the lever 42 out of the detent 46, thereby releasing the tension of the spring 36 and causing eversion of the insert 12. The motorized configuration of the present invention has the advantage of allowing a user to operate the roof gutter clearing system 10 remotely, for example from the interior of a structure, thereby avoiding inclement weather.

The free edge 38 of the insert 12 can optionally include a flexible flapper 100 extending longitudinally across the free edge 38 of the insert 12 and reaching inward to fill any gap between the free edge 38 of the insert 12 and a wall of the gutter G, as illustrated in FIGS. 8A and 8B. Inclusion of the flapper 100 provides the capability of custom fitting the insert 12 to gutters of various widths. The flapper 100 can be provided in various widths or trimmed to a desired width. A jaw 102 extending longitudinally across the free edge 38 of the insert 12 can be provided to accommodate the flapper 100. The flapper 100 includes a proximal edge 104 for insertion into the jaw 102 and a distal edge 106 to abut a wall of the gutter G. The flapper 100 preferably includes a plurality of scores 108 to facilitate custom trimming to the width of a gutter G.

The proximal edge 104 of the flapper 100 can be permanently attached within the jaw 102 for example by means of an adhesive. Alternatively, the flapper 100 can be reversibly mounted within the jaw 102, for example by means of a friction fit, with the thickness of the flapper 100 being slightly greater than the span of the jaw 102. A friction fit configuration provides the capability of interchange of flappers 100. A flapper 100 can be replaced by, for example, sliding a first flapper 100 out of the jaw 102 and sliding in a replacement flapper 100 into the jaw 102.

The flapper 100 is preferably constructed of a semiflexible material that is durable, easily trimmable, and sufficiently flexible to occlude any gap between the insert 12 and the gutter G. Suitable materials include but are not limited to natural rubber, synthetic rubber, polyolefins, polyesters, polyurethanes, and silicone polymers.

To ensure effective coverage of long gutters, it can be desirable to link together the inserts 12 of adjacently mounted roof gutter clearing systems 10. To facilitate this linkage, the insert 12 can include linking means for attaching adjacent inserts. The linking means can include any suitable linking device known in the art. For example the linking means can include a socket 110 in proximity to the free edge 28 of the insert 12, the opposite edge of the insert 12, or both, as illustrated in FIG. 8B. The socket is 110 dimensioned to accommodate a linking pin connected to the socket of an adjacent insert 12 (not shown).

The roof gutter clearing system 10 system can additionally include angled inserts 12 (FIG. 10) adapted to fit the angled gutters of the corners of buildings. The roof gutter clearing system 10 can additionally include and miniature inserts 12 (not shown) of dimensions that cover and clear only areas of a gutter G surrounding the mouths of downspouts.

Although the previously described embodiments of the clearing system of the present invention included roof gutter clearing systems, the clearing system is also readily adapted to clear any type of receptacle that tends to accumulate debris. The clearing system can for example be installed and operated in street gutters and drainage ditches; in settlement areas of water treatment plants and refuse recycling facilities; and in bath and toilet facilities.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims, the invention may be practiced otherwise than as specifically described.

The invention claimed is:

1. A roof gutter clearing system including eversible screening means for collecting and ejecting debris, spring means for storing energy and for applying the energy as eversive force against said eversible screening means, and actuation means for tensioning said spring means and for releasing said spring means to apply eversive force against said screening means, the eversive force causing eversion of said eversible screening means.

2. A roof gutter clearing system including a pivoting insert situated atop a roof gutter, said insert including filtering means to collect debris, said insert being eversible to eject the debris, a spring assembly operatively connected to said insert, said spring assembly being tensionable to store energy and releasable to apply the energy as eversive force applied against said insert, and an actuation assembly operatively connected to said spring assembly, said actuation assembly being operable to tension said spring assembly to store energy, said actuation assembly being additionally operable to release said spring assembly to apply the energy as eversive force against said insert to cause eversion of said insert.

3. The roof gutter clearing system according to claim 2, wherein said spring assembly includes a spring-loaded striker pivotable to apply eversive force against said insert.

4. The roof gutter clearing system according to claim 3, wherein said spring-loaded striker additionally includes a bar-like shaft member pivotally engaged to a mount, and a crossmember connected to said shaft member to apply eversive force against said insert, a coiled spring situated about said shaft member, said spring being tensionable by said actuation assembly, the tension of said coiled spring being releasable by said actuation assembly, said shaft member and said cross member being forcefully pivoted about said mount by the released tension of said spring, the forceful pivoting of said crossmember applying eversive force against said insert to cause eversion of said insert.

5. The roof gutter clearing system according to claim 4, wherein said spring-loaded striker is situated on the floor of a gutter, and wherein said spring-loaded striker is further defined as being forcefully pivotable upward to cause said crossmember to strike a lower surface of said insert to cause eversion of said insert.

6. The roof gutter clearing system according to claim 4 wherein said spring-loaded striker is situated on a lower surface of said insert, and wherein said spring-loaded striker is further defined as being forcefully pivotable downward to cause said crossmember to strike the floor of a gutter and recoil upward to cause eversion of said insert.

7. The roof gutter clearing system according to claim 2, wherein said spring assembly includes a spring-loaded telescoping plunger situated on a lower surface of said insert, said telescoping plunger including at least a distal segment and a proximal segment, said distal segment being forcibly extendable by the release of spring tension to strike the floor of a gutter and induce said insert to recoil upward and evert.

8. The roof gutter clearing system according to claim 2, wherein said actuation assembly includes a pivotable lever operatively connected to said shaft member of said spring-loaded striker, said lever including a first end and an opposite second end, said coiled spring being tensionable by rotation of said lever in a first direction, the tension of said spring being maintainable by the entrapment of said first end of said lever by a detent, said first end of said lever being releasable from said detent by rotational force applied to said lever in a second direction, the release of said first end of said lever from said detent allowing the release of the tension of said spring, the release of spring tension driving the forceful rotation of said spring-loaded striker in said second direction to exert eversive force against said insert.

9. The roof gutter clearing system according to claim 8, wherein said actuation assembly includes a transmission assembly to transmit force exerted on said pivoting lever to said shaft member.

10. The roof gutter clearing system according to claim 2, wherein said spring assembly includes a spring-loaded hinge mounted atop a gutter, said spring-loaded hinge assembly being pivotably engaged to said insert, said spring-loaded hinge assembly being forcefully pivotable to apply eversive force against said insert.

11. The roof gutter clearing system according to claim 10, wherein said spring-loaded hinge assembly additionally includes at least one hinge situated upon an exterior wall of a gutter, said at least one hinge being connected to said insert and in pivoting engagement with a hinge pin, said at least one hinge being operatively engaged to at least one hinge spring, said at least one hinge spring being tensionable to store energy and releasable to drive said at least one hinge to forcefully pivot and apply eversive force against said insert.

12. The roof gutter clearing system according to claim 11, additionally including an actuation assembly operatively engaged to said spring-loaded hinge assembly, to tension said at least one hinge spring to store energy and to release the tension of said at least one hinge spring to drive the forceful pivoting of said at least one hinge to apply eversive force against said insert.

13. The roof gutter clearing system according to claim 12, wherein said actuation assembly includes a pivoting trip assembly situated upon an exterior wall of a gutter and pivotally engaged with said hinge pin, and a loop-like catch situated on said lower surface of said insert, said trip assembly including a trigger having an outer tongue member extending outward from the gutter and an opposite inner hook member extending toward said insert, said hook member being situated to align with and engage said catch, wherein engagement of said hook member with said catch tensions said at least one hinge spring and arrests said insert in a resting position, said trigger being pivotable about said hinge pin upon the application of force to said tongue member, the pivoting of said trigger disengaging said hook member from said catch to release the tension of said at least one hinge spring, to drive the forceful pivoting of said at least one hinge to apply eversive force against said insert.

14. The roof gutter clearing system according to claim 13, wherein said trip assembly additionally includes at least one trigger spring operatively connected to said trigger, to bias said hook member of said trigger into a position to engage said catch.

15. The roof gutter clearing system according to claim 14, wherein said trigger spring is further defined as a helical trigger spring coiled about said hinge pin, said trigger spring including a first arm member in contact with an upper surface of said tongue member and a second arm member in contact with an upper surface of said hook member, said trigger spring being biased to pivot said trigger about said hinge pin to bring said hook member into engagement with said catch.

16. The roof gutter clearing system according to claim 13, wherein said trip mechanism includes a housing having a roof at least partially enclosing said trigger, said housing including a housing spring resiliently connecting said roof of said housing to said upper surface of tongue member of said trigger, said housing spring being biased to exert downward force on said tongue member, to bias said trigger to pivot said hook member upward to engage said catch.

17. The roof gutter clearing system according to claim 12 wherein said actuation assembly includes a pivoting magnetic trip assembly pivotally engaged with said hinge pin, and at least one insert magnet situated on said underside of said insert, said magnetic trip assembly including a magnetic trigger having an outer tongue member extending outward from the gutter and an opposite inner magnet member extending toward said insert, said magnet member having at least one trigger magnet situated on an upper surface of said magnet member, said trigger magnet being aligned with said insert magnet, to magnetically engage said insert magnet, the engagement of said trigger magnet and said insert magnet tensioning said at least one hinge spring and arresting said insert in a resting position, said trigger being pivotable about said hinge pin upon the application of force to said tongue member, the pivoting of said trigger disengaging said trigger magnet from said insert magnet to release the tension of said at least one hinge spring, the released spring tension driving the forceful pivoting of said at least one hinge to apply eversive force against said insert.

18. The roof gutter clearing system according to claim 2, wherein said system is attached to an exterior wall of a roof gutter by attachment means.

19. The roof gutter clearing system according to claim 18, wherein said attachment means includes a clip channel, said clip channel including an upper platform member extending across a lip of a gutter and terminating in an inner end, and a lower leg member extending downward from said inner end of said platform member, to contact a face of the wall of the gutter, the combination of said platform member and said leg member grippingly engaging the wall of the gutter.

20. The roof gutter clearing system according to claim 2, wherein said actuation assembly is operable by a remote force transfer device selected from the group consisting of a pole, a chain, a rope, a pulley system, and an electric motor.

21. The roof gutter clearing system according to claim 2, wherein said insert includes a flexible flapper extending longitudinally across a free edge of said insert 12 to fill any gap between said free edge of said insert 12 and a wall of a gutter.

22. The roof gutter clearing system according to claim 2, wherein said insert includes at linkage means for linking said insert to an adjacent insert.

23. The roof gutter clearing system according to claim 2, wherein said insert is further defined as an angled insert adapted to fit an angled corner of a gutter.

24. A method of clearing a roof gutter of debris, including the steps of: of trapping debris in an pivoting insert, the insert being situated atop the roof gutter and operatively connected to a spring assembly tensioned to store energy; and releasing the spring assembly to apply the energy as eversive force against the insert to cause eversion of the insert and ejection of the debris.

25. A receptacle clearing system including eversible screening means for collecting and ejecting debris, spring means for storing energy and for applying the energy as eversive force against said eversible screening means, and actuation means for tensioning said spring means and for releasing said spring means to apply eversive force against said screening means, the eversive force causing eversion of said eversible screening means.
